(19) United States
(12) Patent Application Publication
(10) Pub. No.: US 2014/0210423 A1
(43) Pub. Date: Jul. 31, 2014

(54) ENERGY HARVESTING DEVICE

(71) Applicant: PANASONIC CORPORATION, Osaka (JP)

(72) Inventors: Koji Goto, Osaka (JP); Norihiro Yamauchi, Osaka (JP); Koichi Aizawa, Osaka (JP); Shinji Sakamoto, Osaka (JP); Toyohiko Tsujimoto, Osaka (JP)

(73) Assignee: PANASONIC CORPORATION, Osaka (JP)

(21) Appl. No.: 14/342,796

(22) PCT Filed: Nov. 6, 2012
(86) PCT No.: PCT/JP2012/078737

§ 371 Date: Mar. 5, 2014

(30) Foreign Application Priority Data
Nov. 9, 2011 (JP) 2011-245508

(51) Int. Cl. H02J 7/00

(52) U.S. Cl. CPC H02J 7/0052; H02J 2007/0059
USPC 320/139

(57) ABSTRACT

The energy harvesting device includes a power management circuit to charge a storage with power from a generator including generation units to generate AC power when vibrated. The power management circuit includes: a first power extraction circuit including a rectification circuit converting AC power at a first input unit into DC power; a second power extraction circuit including a switching circuit operating with power from the storage and generating DC power using AC power at a second input unit; and a switch circuit having a first connection mode of connecting the first input unit to the generation units to receive an AC voltage greater in effective value than an AC voltage to the second input unit, and a second connection mode of connecting the second input unit to the generation units to receive an AC voltage greater in effective value than an AC voltage to the first input unit.

### TECHNICAL FIELD

The present invention relates to energy harvesting devices.

### BACKGROUND ART

Electric generators (piezoelectric vibration energy harvester) that convert vibration energy into electric energy using piezoelectric elements have attracted attention in the field of energy harvesting, and have been studied and developed in various organizations (see document 1[R. van Schaijk, et al, “Piezoelectric AlN energy harvesters for wireless autonomoustransducer solutions”, IEEE SENSORS 2008 Conference, 2008, p. 45-48], and document 2 [S Roundy and P K Wright, “A piezoelectric vibration based generator for wireless electronics”, Smart Materials and Structures 13, 2004, p 1131-1142]). Document 1 discloses that material of piezoelectric elements is PZT(Pb(Zr,Ti)O₃), and document 2 discloses that material of piezoelectric elements is PZT and aluminum nitride (AlN).

The electric generators can be classified by types of piezoelectric elements such as thin film types and bulk types. Document 1 discloses thin film type electric generators formed by using a micromachining technique. Document 2 discloses bulk type electric generators.

FIG. 10 shows an electric generator disclosed in document 1. The electric generator includes a device substrate 301 formed of a silicon substrate 300.

This device substrate 301 includes: a support 311 having a rectangular frame shape; a cantilever (beam) 312 situated inside the support 311 and swingably supported by the support 311; and a weight 313 provided at a free end of the cantilever 312.

The electric generator includes an electric generation portion 320. The electric generation portion 320 is provided on the cantilever 312 of the device substrate 301 and is configured to generate an AC voltage in response to a vibration of the cantilever 312.

The electric generation portion 320 includes: a lower electrode 322; a piezoelectric film 321 on the opposite side of the lower electrode 322 from the cantilever 312; and an upper electrode 323 on the opposite side of the piezoelectric film from the lower electrode 322.

In this electric generation portion 320, the lower electrode 322 is a Pt film, and the piezoelectric film 321 is an AlN film or a PZT film, and the upper electrode 323 is an Al film.

The electric generator includes an upper cover substrate 401 and a lower cover substrate 501. The upper cover substrate 401 is situated over a first surface (upper surface in FIG. 10) of the device substrate 301 and is bonded to the support 311. The lower cover substrate 501 is situated over a second surface (lower surface in FIG. 10) of the device substrate 301 and is bonded to the support 311.

The upper cover substrate 401 and the lower cover substrate 501 are formed of a glass substrate 400 and a glass substrate 500, respectively.

The device substrate 301 has a movable portion constituted by the cantilever 312 and the weight 313. Spaces 426 and 526 for allowing displacement of the movable portion are formed between the movable portion and the upper cover substrate 401 and between the movable portion and the lower cover substrate 501, respectively.

An electric generator disclosed in document 2 includes: a support; a cantilever swingably supported by the support; and a weight provided at an end of the cantilever that is not supported by the support. The cantilever is a bimorph piezoelectric element including stacked two layers of piezoelectric elements.

Further, document 2 discloses an equivalent circuit model of a system including the electric generator. FIG. 11 shows a circuit diagram of this equivalent circuit model.

The equivalent circuit of the electric generator is constituted by: an equivalent inductor Lₘ representing the mass or the inertia of the weight; an equivalent resistor R_{b} representing mechanical damping; an equivalent capacitor Cₖ representing mechanical stiffness; an equivalent stress Gin caused by an external vibration; an equivalent turn ratio “n” of a transformer; and a capacitor C_{b} representing the electric generation portion.

This equivalent circuit model includes a full-wave rectifier and a storage capacitor Cₛₜ. The full-wave rectifier is constituted by a bridge circuit of four diodes D1, D2, D3, and D4, and performs full-wave rectification on an output voltage “v” of the electric generator. The storage capacitor Cₛₜ is connected between output terminals of the full-wave rectifier.

The electric generator disclosed in document 1 is a thin film type electric generator. Such a thin film electric generator can be downsized more than a bulk type electric generator disclosed in document 2. Whereas, the thin film type electric generator is lower in output voltage than such a bulk type electric generator. Hence, improvement of the output voltage of the thin film type electric generator has been desired.

An energy harvesting device for storing an output from the electric generator disclosed in document 1 in a capacitor may have a structure in which a full-wave rectifier is connected between output terminals of an electric generation device in a similar manner to that in document 2.

However, in this energy harvesting device, voltage losses (forward voltage drops) may occur in the two diodes D1 and D4 in a positive half cycle of the output voltage “v” of the electric generator, and other voltage losses may occur in the two diodes D3 and D2 in a negative half cycle of the output voltage “v” of the electric generator.

Additionally, in the positive half cycle of the output voltage “v” of the electric generator, this energy harvesting device cannot extract electricity except for a period in which the absolute value of the output voltage “v” is not less than a total of threshold voltages of the two diodes D1 and D4. Similarly, in the negative half cycle of the output voltage “v” of the electric generator, this energy harvesting device cannot extract electricity except for a period in which the absolute value of the output voltage “v” is not less than a total of threshold voltages of the two diodes D3 and D2. Hence, it seems to be difficult to charge the storage capacitor Cₛₜ efficiently.

### SUMMARY OF INVENTION

In view of the above insufficiency, the present invention has aimed to propose an energy harvesting device capable of charging the electric storage unit efficiently. The energy harvesting device of the first aspect in accordance with the present invention, includes: an electric generator for charging an electric storage; and an power management circuit configured to operate with power from the electric storage, and to charge the electric storage with power from the electric generator. The electric generator includes two or more electric generation portions each configured to generate AC power when vibrated. The power management circuit includes a first power extraction circuit, a second power extraction circuit, and a switch circuit. The first power extraction circuit includes a first input unit, a first output unit, and a rectification circuit between the first input unit and the first output unit. The rectification circuit is configured to convert AC power received by the first input unit into DC power and provide the converted DC power to the first output unit. The second power extraction circuit includes a second input unit, a second output unit, and a switching circuit which is between the second input unit and the second output unit and is configured to operate with power supplied from the electric storage. The switching circuit is configured to generate DC power by use of AC power received by the second input unit and provide the generated DC power to the second output unit. The switch circuit has a first connection mode of connecting the electric generator and the electric storage to the first input unit and the first output unit, respectively, and a second connection mode of connecting the electric generator and the electric storage to the second input unit and the second output unit, respectively. The switch circuit is configured to, in the first connection mode, connect the two or more electric generation portions to the first input unit such that an effective value of an AC voltage to be provided to the first input unit in the first connection mode is greater than an effective value of an AC voltage to be provided to the second input unit in the second connection mode. The switch circuit is configured to, in the second connection mode, connect the two or more electric generation portions to the second input unit such that the effective value of the AC voltage to be provided to the second input unit in the second connection mode is greater than the effective value of the AC voltage to be provided to the first input unit in the first connection mode.

According to the energy harvesting device of the second aspect in accordance with the present invention, in addition to the first aspect, the switch circuit is configured to, in the first connection mode, make a series circuit of the two or more electric generation portions and connect the series circuit to the first input unit, and is configured to, in the second connection mode, make a parallel circuit of the two or more electric generation portions and connect the parallel circuit to the second input unit.

According to the energy harvesting device of the third aspect in accordance with the present invention, in addition to the first or second aspect, the power management circuit includes a controller configured to operate with power from the electric storage. The controller is configured to, when an output voltage of the electric storage is not less than a predetermined voltage, switch the switch circuit from the first connection mode to the second connection mode.

According to the energy harvesting device of the fourth aspect in accordance with the present invention, in addition to the third aspect, the predetermined voltage is a minimum operating voltage of the power management circuit.

According to the energy harvesting device of the fifth aspect in accordance with the present invention, in addition to the fourth aspect, the minimum operating voltage of the power management circuit is not less than a minimum operating voltage of the second power extraction circuit and also is not less than a minimum operating voltage of the controller.

According to the energy harvesting device of the sixth aspect in accordance with the present invention, in addition to any one of the first to fifth aspects, the switch circuit is configured to be in the first connection mode while an output voltage of the electric storage is less than a predetermined voltage.

According to the energy harvesting device of the seventh aspect in accordance with the present invention, in addition to the sixth aspect, the switch circuit includes a first switch device between the electric generator and the first input unit, a second switch device between the electric storage and the first output unit, a third switch device between the electric generator and the second input unit, and a fourth switch device between the electric storage and the second output unit. Each of the first switch device and the second switch device is a normally-on switch. Each of the third switch device and the fourth switch device is a normally-off switch.

The energy harvesting device of the eighth aspect in accordance with the present invention, in addition to any one of the first to seventh aspects, further includes the electric storage.

According to the energy harvesting device of the ninth aspect in accordance with the present invention, in addition to the eighth aspect, the electric storage includes a first capacitive element and a second capacitive element. The rectification circuit includes a first rectifying element and a second rectifying element. The first input unit includes a first input terminal and a second input terminal. The first output unit includes a first output terminal, a second output terminal, and a third output terminal. An anode of the first rectifying element and a cathode of the second rectifying element are connected to the first input terminal. A cathode of the first rectifying element is connected to the first output terminal. An anode of the second rectifying element is connected to the second output terminal. The second input terminal is connected to the third output terminal. The switch circuit is configured to, in the first connection mode, connect the two or more electric generation portions in series between the first input terminal and the second input terminal, connect the first capacitive element and the second capacitive element in series between the first output terminal and the second output terminal, and connect the third output terminal to a connection point of the first capacitive element and the second capacitive element.

According to the energy harvesting device of the tenth aspect in accordance with the present invention, in addition to any one of the first to ninth aspects, the switching circuit includes: an energy storage device; a first switch unit between the second input unit and the energy storage device; a second switch unit between the second output unit and the energy storage device; and a control circuit configured to operate with power from the electric storage, and configured to control the first switch unit and the second switch unit to convert an AC voltage received by the second input unit to a DC voltage and provide the converted DC voltage to the second output unit.

According to the energy harvesting device of the eleventh aspect in accordance with the present invention, in addition to the tenth aspect, the control circuit is configured to, while an AC voltage to be provided to the second input unit has a positive or negative polarity, perform a storing operation in which the control circuit keeps turning off the second switch unit and controls the first switch unit so as to store energy in the energy storage device. The control circuit is configured to, when an AC voltage to be provided to the second input unit becomes zero, start a discharging operation in which the control circuit turns off the first switch unit and turns on the second switch unit so as to allow the energy storage device to provide a DC voltage to the second output unit.

According to the energy harvesting device of the twelfth aspect in accordance with the present invention, in addition to the tenth or eleventh aspect, the second input unit includes a third input terminal and a fourth input terminal. The second output unit includes a fourth output terminal, and a fifth output terminal. The first switch unit includes a first switch between a first end of the energy storage device and the third input terminal, a second switch between a second end of the energy storage device and the fourth input terminal, a third switch between the first end of the energy storage device and the fourth input terminal, and a fourth switch between the second end of the energy storage device and the third input terminal. The second switch unit includes a fifth switch between the first end of the energy storage device and the fourth output terminal, and a sixth switch between the second end of the energy storage device and the fifth output terminal. The switch circuit is configured to, in the second connection mode, connect the two or more electric generation portions in parallel between the third input terminal and the fourth input terminal and connect the electric storage between the fourth output terminal and the fifth output terminal. The control circuit is configured to: while an AC voltage to be provided to the second input unit has one of a positive polarity and a negative polarity, turn on the first switch and the second switch and turn off the third switch and the fourth switch while turning off the fifth switch and the sixth switch, so as to perform the storing operation; while an AC voltage to be provided to the second input unit has the other of the positive polarity and the negative polarity, turn off the first switch and the second switch and turn on the third switch and the fourth switch while turning off the fifth switch and the sixth switch, so as to perform the storing operation; and when an AC voltage to be provided to the second input unit becomes zero, turn off the first switch, the second switch, the third switch, and the fourth switch and turn on the fifth switch and the sixth switch, so as to perform the discharging operation.

The energy harvesting device of the thirteenth aspect in accordance with the present invention, in addition to the eleventh or twelfth aspect, further includes a displacement measurement sensor. The electric generator includes a movable portion which is movable from a basic position in response to a vibration given thereto. The two or more electric generation portions are provided to the movable portion, and each configured to generate AC power depending on a displacement of the movable portion from the basic position. The displacement measurement sensor is configured to measure the displacement of the movable portion from the basic position. The control circuit is configured to, when the displacement of the movable portion from the basic position measured by the displacement measurement sensor becomes zero, start the discharging operation.

According to the energy harvesting device of the fourteenth aspect in accordance with the present invention, in addition to the thirteenth aspect, the displacement measurement sensor is a capacitance displacement measurement sensor.

The energy harvesting device of the fifteenth aspect in accordance with the present invention, in addition to the eleventh or twelfth aspect, further includes a current measurement device. The current measurement device is configured to measure an alternating current supplied to the second input unit. The control circuit is configured to, when the current measured by the current measurement device becomes zero, start the discharging operation.

### BRIEF DESCRIPTION OF THE DRAWINGS

FIG. 1 is a diagram illustrating a circuit of an energy harvesting device of the first embodiment;

FIG. 2 is a schematic plan view illustrating a piezoelectric vibration energy harvester in the energy harvesting device of the first embodiment;

FIG. 3 is a schematic sectional view along line A-A′ of FIG. 2;

FIG. 4 is a diagram illustrating an operation in the first connection mode of the energy harvesting device of the first embodiment;

FIG. 5 is a diagram illustrating an operation in the second connection mode of the energy harvesting device of the first embodiment;

FIG. 6 is a diagram illustrating an operation in the second connection mode of the energy harvesting device of the first embodiment;

FIG. 7 is a diagram illustrating an operation in the second connection mode of the energy harvesting device of the first embodiment;

FIG. 8 is a diagram illustrating an operation in the second connection mode of the energy harvesting device of the first embodiment;

FIG. 9 is a diagram illustrating a circuit of an energy harvesting device of the second embodiment;

FIG. 10 is a sectional view illustrating the prior energy harvesting device; and

FIG. 11 is a diagram illustrating an equivalent circuit model of a system including the other prior energy harvesting device.

### DESCRIPTION OF EMBODIMENTS

### First Embodiment

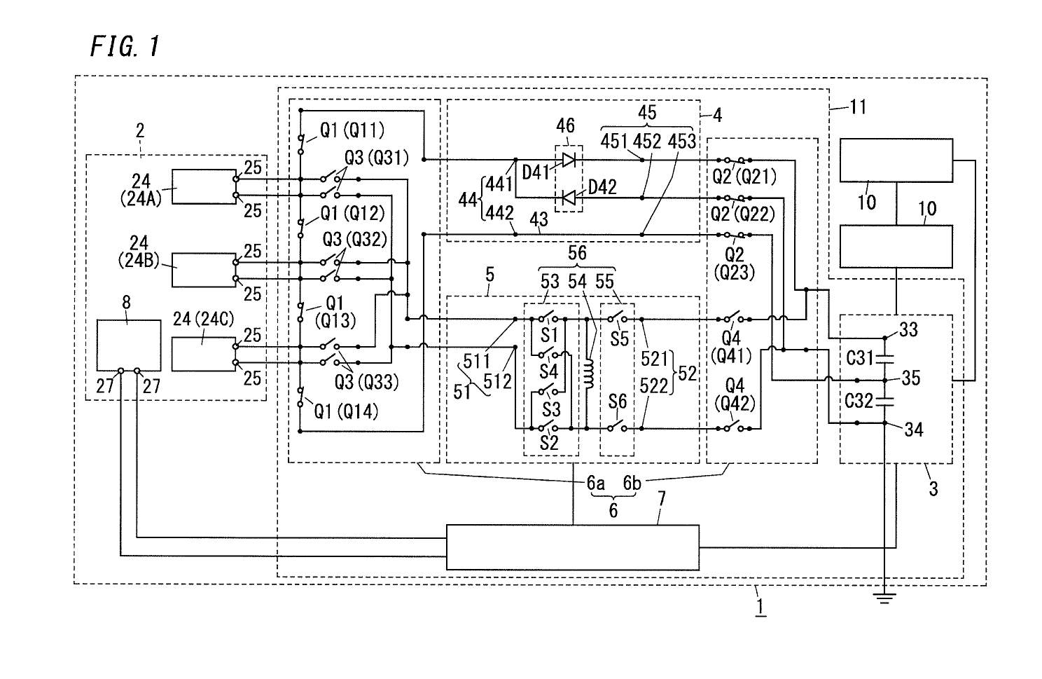

Hereinafter, the energy harvesting device of the present embodiment is described with reference to FIGS. 1 to 8.

The energy harvesting device 1 includes a piezoelectric vibration energy harvester (electric generator) 2 and an electric storage unit (electric storage) 3. The piezoelectric vibration energy harvester 2 includes two or more (in the present embodiment, three) electric generation portions 24 (24A, 24B, and 24C). Each electric generation portion 24 is configured to generate an AC voltage when receiving an environmental vibration.

The energy harvesting device 1 includes a first power extraction circuit 4. The first power extraction circuit 4 is constituted by two diodes D41 and D42 for rectification. The first power extraction circuit 4 is configured to rectify the AC voltage from the piezoelectric vibration energy harvester 2 to charge (recharge) the electric storage unit 3.

The energy harvesting device 1 includes a second power extraction circuit 5. The second power extraction circuit 5 includes electronic analog switches S1 to S6 (hereinafter referred to as first to sixth electronic analog switches) and an energy storage device 54. The second power extraction circuit 5 is configured to receive an AC voltage from the piezoelectric vibration energy harvester 2 and charge the electric storage unit 3 with power derived from the received AC voltage.

The energy harvesting device 1 includes a switch circuit 6 configured to switch between a first connection mode and a second connection mode selectively. In the first connection mode. the energy harvesting device 1 charges the electric storage unit 3 by use of the first power extraction circuit 4. In the second connection mode, the energy harvesting device 1 charges the electric storage unit 3 by use of the second power extraction circuit 5.

The energy harvesting device 1 includes a controller 7. The controller 7 is configured to use power from the electric storage unit 3 to control the second power extraction circuit 5 and the switch circuit 6. In other words, the controller 7 operates on electricity from the electric storage 3.

The energy harvesting device 1 includes a power management circuit 11 configured to manage power (electricity) generated by the piezoelectric vibration energy harvester 2. The power management circuit 11 is constituted by the first power extraction circuit 4, the second power extraction circuit 5, the electric storage unit 3, the switch circuit 6, and the controller 7.

The controller 7 is configured to, when an output voltage of the electric storage 3 is not less than a predetermined voltage, switch the switch circuit 6 from the first connection mode to the second connection mode. For example, the predetermined voltage is a minimum operating voltage of the power management circuit 11. The minimum operating voltage of the power management circuit 11 is not less than a minimum operating voltage of the second power extraction circuit and also is not less than a minimum operating voltage of the controller 7.

While the switch circuit 6 has the first connection mode, the switch circuit 6 connects a series circuit of the two or more electric generation portions 24 between input terminals 441 and 442 of the first power extraction circuit 4 and connects the electric storage unit 3 between output terminals 451 and 452 of the first power extraction circuit 4.

While the switch circuit 6 has the second connection mode, the switch circuit 6 connects a parallel circuit of the two or more electric generation portions 24 between input terminals 511 and 512 of the second power extraction circuit 5 and connects the electric storage unit 3 between output terminals 521 and 522 of the second power extraction circuit 5.

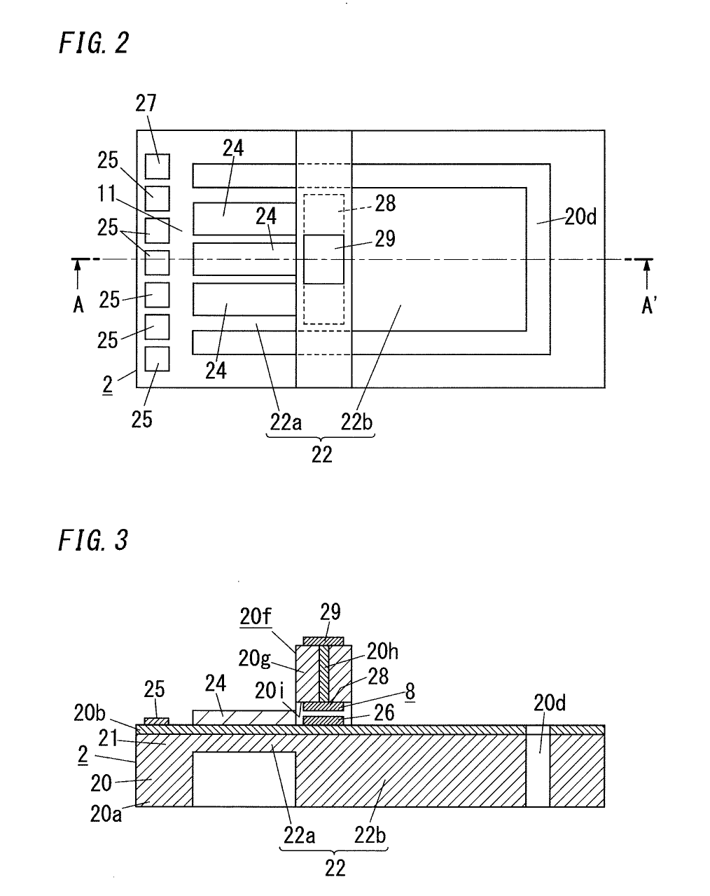

As shown in FIGS. 2 and 3, preferably the piezoelectric vibration energy harvester 2 includes a supporting portion 21 and a movable portion 22. The movable portion 22 is swingably supported by the supporting portion 21, and vibrates in response to an environmental vibration. The aforementioned two or more electric generation portions 24 are on the movable portion 22.

Preferably, the energy harvesting device 1 further includes a displacement measurement sensor 8. The displacement measurement sensor 8 is configured to determine a displacement of the movable portion 22. The controller 7 turns on and off the electronic analog switches S1 to S6 at near a zero crossing of an AC signal from the displacement measurement sensor 8.

The components of the energy harvesting device 1 are described in more detail hereinafter.

The piezoelectric vibration energy harvester 2 includes a device substrate 20 including the supporting portion 21, a cantilever 22a, and a weight 22b. The cantilever 22a is swingably supported by the supporting portion 21 at one end. The weight 22b is provided to the other end of the cantilever 22a from the supporting portion 21.

The cantilever 22a and the weight 22b constitute the movable portion 22 of the piezoelectric vibration energy harvester 2. The two or more electric generation portions 24 are situated on the cantilever 22a.

Accordingly, the piezoelectric vibration energy harvester 2 generates an AC voltage in response to a vibration of the cantilever 22a.

In other words, the electric generator 2 includes the movable portion 22 which is movable from a basic position in response to a vibration. The two or more electric generation portions 24 are provided to the movable portion 22, and each configured to generate AC power depending on displacement of the movable portion 22 from the basic position.

The device substrate 20 is formed by use of a first substrate 20a. The first substrate 20a may be a single crystal silicon substrate with a first surface which is a (100) surface. The first substrate 20a is not limited thereto, and may be a polycrystalline silicon substrate.

An insulating film 20b is on the first surface of the first substrate 20a of the device substrate 20 and electrically insulates the electric generation portions 24 from the first substrate 20a.

The first substrate 20a is not limited to a silicon substrate, but may be one selected from an SOI (Silicon on Insulator) substrate, a magnesium oxide (MgO) substrate, a metal substrate, a glass substrate, and a polymer substrate, for example. When the first substrate 20a is an insulator substrate such as an MgO substrate, a glass substrate, and a polymer substrate, the insulating film 20b is not necessary but may be provided.

The supporting portion 21 of the device substrate 20 has a frame shape (in the present embodiment, a rectangular frame shape). The cantilever 22a and the weight 22b are situated inside the supporting portion 21.

The device substrate 20 includes a slit 20d having a U-shape in a plan view. The slit 20d surrounds the movable portion 22 constituted by the cantilever 22a and the weight 22b. Thus, the movable portion 22 is spatially separated from the supporting portion 21 except for a connection part of the movable portion 22 connected to the supporting portion 21.

It is sufficient that the supporting portion 21 has such a shape as to support the movable portion 22 swingably. Hence, the supporting portion 21 need not have a frame shape.

The electric generation portions 24 are formed over the first surface of the device substrate 20. Each electric generation portion 24 is constituted by a piezoelectric converter including a pair of two electrodes opposite each other and a piezoelectric element between the pair of two electrodes. The pair of two electrodes of the electric generation portion 24 are arranged over a first surface of the cantilever 22a of a thickness direction of the cantilever 22a so as to be separate from each other in this thickness direction.

In the piezoelectric vibration energy harvester 2, a vibration of the movable portion 22 applies a mechanical stress to the piezoelectric element of the electric generation portion 24 and this applied stress causes a difference between charge densities between one and the other of the two electrodes. Thus, the electric generation portion 24 generates an AC voltage. In brief, the electric generation portion 24 of the piezoelectric vibration energy harvester 2 generates electricity by use of a piezoelectric effect of a piezoelectric material.

The piezoelectric vibration energy harvester 2 has an open voltage which is a sinusoidal AC voltage depending on a vibration of the piezoelectric element caused by an environmental vibration.

The piezoelectric vibration energy harvester 2 is designed to generate electricity by use of an environmental vibration with a frequency equal to a resonance frequency of the piezoelectric vibration energy harvester 2. Such an environmental vibration may include various environmental vibrations (external vibrations) such as a vibration caused by an FA device in operation, a vibration caused by a vehicle in motion, and a vibration caused by human walking.

When the frequency of the environmental vibration is equal to the resonance frequency of the energy harvesting device 1, a frequency of the AC voltage generated by the energy harvesting device 1 is the same as the resonance frequency of the energy harvesting device 1.

Note that, the external vibrations may include various environmental vibrations such as a vibration caused by an FA device in operation, a vibration caused by a vehicle in motion, and a vibration caused by human walking, for example. In the present embodiment, an FA device which causes a vibration with a frequency of 475 Hz is considered as an external vibration source which causes such an external vibration. Each of the two or more electric generation portions 24 of the piezoelectric vibration energy harvester 2 serves as a polar capacitor.

The piezoelectric material of the piezoelectric element is PZT. However, the piezoelectric material is not limited thereto but may be PZT-PMN(Pb(Mn,Nb)O₃) or PZT doped with other impurities. Alternatively, the piezoelectric material may be selected from AlN, ZnO, KNN (K_{0.5}Na_{0.5}NbO₃), KN (KNbO₃), NN (NaNbO₃), and KNN doped with impurities (e.g., Li, Nb, Ta, Sb, and Cu).

The pair of two electrodes includes one electrode (hereinafter referred to as “first electrode”, if necessary) situated on one side of the piezoelectric element close to the movable portion 22, and the other electrode (hereinafter referred to as “second electrode”, if necessary) situated on the opposite side of the piezoelectric element from the movable portion 22. The first electrode may be of Pt, Au, Al, or Ir, for example. The second electrode may be of Au, Mo, Al, Pt, or Ir, for example.

The piezoelectric vibration energy harvester 2 is a thin electric generator. For example, the first electrode has a thickness of 500 nm, the piezoelectric element has a thickness of 600 nm, and the second electrode has a thickness of 100 nm. These values are merely examples and these thicknesses are not limited to particular values.

The first electrode may be formed with a combination of a thin film formation technique (e.g., sputtering, CVD, and vapor deposition) and a patterning technique using a photolithography technique and an etching technique.

The piezoelectric element may be formed with a combination of a thin film formation technique (e.g., sputtering, CVD, and a sol-gel process) and a patterning technique using a photolithography technique and an etching technique.

The second electrode may be formed with a combination of a thin film formation technique (e.g., sputtering, CVD, and vapor deposition) and a patterning technique using a photolithography technique and an etching technique.

Alternatively, the second electrode may be a sheet electrode (also referred to as “electrode sheet”), for example. The second electrode of the sheet electrode may be provided to the piezoelectric element by overlaying the piezoelectric element with the second electrode of the sheet electrode with a vacuum lamination method. The sheet electrode may be metal foil such as aluminum foil, for example. Alternatively the sheet electrode may be obtained by coating a lamination sheet with electrode material with sputtering.

The piezoelectric vibration energy harvester 2 may include a buffer layer between the device substrate 20 and the first electrode. The buffer layer may be of material appropriately selected depending on the piezoelectric material of the piezoelectric element. When the piezoelectric material of the piezoelectric element is PZT, it is preferable that the buffer layer be of SrRuO₃, (Pb,La)TiO₃, PbTiO₃, MgO, or LaNiO₃, for example. Alternatively, the buffer layer may be a laminate of a Pt film and a SrRuO₃ film, for example. Provision of the buffer layer can cause an improvement of crystallinity of the piezoelectric element.

The piezoelectric vibration energy harvester 2 includes two or more (in the present embodiment, six) pads 25. The pads 25 are situated on the first surface of the device substrate 20. The pads 25 are electrically connected to electrodes including the first electrodes and the second electrodes of the electric generation portions 24.

In summary, in the piezoelectric vibration energy harvester 2, the pads 25 are associated with the electrodes individually, and each pad 25 is electrically connected to an associated electrode through a wire (metal wire) not shown. Within the piezoelectric vibration energy harvester 2 itself, the electric generation portions 24 are electrically insulated from each other.

Each pad 25 is formed on a portion of the device substrate 20 corresponding to the supporting portion 21.

The switch circuit 6 can connect all the electric generation portions 24 of the piezoelectric vibration energy harvester 2 in series or in parallel with each other. When all the electric generation portions 24 are connected in series with each other, the piezoelectric vibration energy harvester 2 can produce the output voltage greater than the output voltage from a single electric generation portion with a size equal to the total of the sizes of all the electric generation portions 24. The switch circuit 6 is described later.

The piezoelectric vibration energy harvester 2 further includes two pads 27 and 29 of the displacement measurement sensor 8 in addition to the aforementioned pads 25. The displacement measurement sensor 8 is described later.

The structure of the electric generation portion 24 is not limited to the aforementioned example. For example, the electric generation portion 24 may have a modified structure in which the pair of two electrodes are electrodes formed on opposite side surfaces of the piezoelectric element close to the weight 22b and the supporting portion 21 over the first surface of the cantilever 22a in the thickness direction of the cantilever 22a respectively. In this case, each electrode may be of Au, Pt, Ir, Al, or Mo, for example.

Each electrode may be constituted by a first conductive film on the corresponding side surface of the piezoelectric element and a second conductive film on this first conductive electrode. In this case, the second conductive film may be of Au, Pt, Ir, Al, or Mo, and the first conductive film may be of Ti. This can cause an improvement of adhesiveness between the piezoelectric element and each electrode. The material of the first conductive film may be appropriately selected depending on materials of the piezoelectric element and the second conductive film. For example, the material of the first conductive film may be selected from Cr, TiN, and TaN in addition to Ti.

In the aforementioned modified structure, with regard to thicknesses in the thickness direction of the cantilever 22a, the piezoelectric element has a thickness of 600 nm, and each electrode has a thickness of 600 nm. These thicknesses are not limited.

The aforementioned modified structure may include a buffer layer between the device substrate 20 and the first electrode. Provision of the buffer layer can cause an improvement of crystallinity of the piezoelectric element and therefore can cause an improvement of piezoelectricity of the piezoelectric element. The buffer layer may be of material appropriately selected depending on the piezoelectric material of the piezoelectric element. When the piezoelectric material of the piezoelectric element is PZT, it is preferable that the buffer layer be of SrRuO₃, (Pb,La)TiO₃, PbTiO₃, MgO, or LaNiO₃, for example. Alternatively, the buffer layer may be a laminate of a Pt film and a SrRuO₃ film, for example.

The displacement measurement sensor 8 is a capacitance displacement measurement sensor. The displacement measurement sensor 8 includes a movable electrode 26 and a fixed electrode 28. The movable electrode 26 is provided to the movable portion 22, and the fixed electrode 28 is opposite the movable electrode 26.

The fixed electrode 28 is provided to a second substrate 20f bonded to the device substrate 20.

The second substrate 20f is formed of a glass substrate 20g. The second substrate 20f is provided with a first recess 20i in a side opposite the device substrate 20. The first recess 20i forms a space for swing of the movable portion 22. The fixed electrode 28 is on an inner bottom surface of the first recess 201.

The piezoelectric vibration energy harvester 2 may include a cover substrate bonded to a second surface of the device substrate 20. The cover substrate includes a second recess for forming a space for allowing swing of the movable portion 22.

With regard to the energy harvesting device 1, instead of bonding the cover substrate to the piezoelectric vibration energy harvester 2, a second recess or an opening (through hole) for allowing swing of the movable portion 22 may be provide to a mounting substrate (e.g., a printed wiring board and a package) on which the piezoelectric vibration energy harvester 2 is to be mounted.

The displacement measurement sensor 8 includes the pad 27 and the pad 29. The pad 27 is electrically connected to the movable electrode 26 through a metal wire not shown. The pad 29 is electrically connected to the fixed electrode 28 through a through hole wire 20h penetrating through the glass substrate 20g in a thickness direction of the glass substrate 20g. The second substrate 20f is positioned such that the fixed electrode 28 is situated on the side facing the movable portion 22 and the pad 29 is situated on the opposite side of the second substrate 20f from the movable portion 22.

As clearly understood from the above description, the displacement measurement sensor 8 that is a capacitance displacement measurement sensor includes a variable capacity capacitor having a pair of electrodes defined by the movable electrode 26 and the fixed electrode 28.

According to the displacement measurement sensor 8, a capacitance of the variable capacity capacitor varies with a change in a distance between the movable electrode 26 and the fixed electrode 28 caused by a vibration (swing) of the movable portion 22. Consequently, the capacitance of the displacement measurement sensor varies depending on a displacement of the movable electrode 26.

While a DC bias voltage is applied between the movable electrode 26 and the fixed electrode 28 by the controller 7, a slight change in the voltage between the movable electrode 26 and the fixed electrode 28 occurs depending on a change in the electrostatic capacitance. Accordingly, the controller 7 can determine the displacement of the movable portion 22 with reference to the change in this voltage.

As described above, the displacement measurement sensor 8 is configured to measure the displacement of the movable portion 22 from the basic position.

The structure of the piezoelectric vibration energy harvester 2 is not limited to the aforementioned example. For example, in another structure of the piezoelectric vibration energy harvester 2, a first cover substrate and a second cover substrate may be bonded to the opposite sides of the device substrate 20 in the thickness direction of the device substrate 20.

In this structure, for example, preferably, the first cover substrate and the second cover substrate include a first recess and a second recess respectively, each of the first recess and the second recess forms a space for allowing swing of the movable portion 22, and the fixed electrode 28 is situated on an inner bottom surface of the first recess.

According to this structure, it is possible to increase the mass of the weight 22b of the movable portion 22 of the piezoelectric vibration energy harvester 2, in contrast to a structure in which the first substrate and the second substrate are devoid of the first recess and the second recess respectively and the opposite surfaces of the movable portion 22 are closer to the center of the first substrate 20a than the opposite surfaces of the first substrate 20a in the thickness direction of the first substrate 20a are.

The structure of the displacement measurement sensor 8 is not limited to the aforementioned example, however, it is preferable that the displacement measurement sensor 8 be a capacitance displacement measurement sensor. In contrast to the energy harvesting device 1 including the displacement measurement sensor 8 that is a piezoelectric displacement measurement sensor, it is possible to reduce power necessary to measure a displacement of the movable portion 22 by the displacement measurement sensor 8.

As described above, it is preferable that the controller 7 turn on and off the electronic analog switches S1 to S6 of the second power extraction circuit 5 at near the zero crossing of the AC signal outputted from the displacement measurement sensor 8.

The controller 7 outputs control signals for turning on and off the electronic analog switches S1 to S6. Accordingly, the energy harvesting device 1 in the second connection mode can efficiently extract generated electricity from the piezoelectric vibration energy harvester 2. As a result of that, the electric storage unit 3 can be charged efficiently.

While a functional device 10 is connected between opposite ends of the electric storage unit 3, the energy harvesting device 1 can allow the functional device 10 to operate on electricity from the electric storage unit 3.

The functional device 10 may be selected from a sensor (e.g., a temperature sensor, an acceleration sensor, a pressure sensor), a solid light emitting device (e.g., a light emitting diode and a semiconductor laser diode), and an arithmetic device (e.g., a wireless communication device and an MPU [Micro Processor Unit]). The number of functional devices 10 and the connection configuration thereof may be appropriately determined based on the application of the energy harvesting device 1.

The electric storage (electric storage unit) 3 includes a capacitor C31 serving as a first capacitive element and a capacitor C32 serving as a second capacitive element. Each of the first capacitive element and the second capacitive element may be constituted by two or more capacitors.

The electric storage 3 includes a first power terminal 33, a second power terminal 34, and a ground terminal 35. In the present embodiment, the capacitor C31 has a first end connected to a first end of the capacitor C32. The first power terminal 33 is a second end of the capacitor C31. The second power terminal 34 is a second end of the capacitor C32. The ground terminal 35 is a connection point of the first ends of the capacitors C31 and C32.

The electric storage unit 3 is a series circuit of the two capacitors C31 and C32. Further, the capacitors C31 and C32 have the same specification and have the same characteristics.

Each of the capacitors C31 and C32 has a capacitance of 10 μF. This numerical value is merely an example, and does not give any limitations.

Each of the capacitors C31 and C32 is a surface-mount capacitor. However, each of the capacitors C31 and C32 is not limited to such a surface-mount capacitor.

Hereinafter, the capacitor C31 is referred as a first capacitor C31, and the other capacitor C32 is referred to as a second capacitor C32, depending on a situation.

The electric storage unit 3 is not limited to a circuit of the two capacitors C31 and C32 but may be a single capacitor.

The first power extraction circuit 4 includes a first input unit 44, a first output unit 45, and a rectification circuit 46 between the first input unit 44 and the first output unit 45.

The rectification circuit 46 is configured to convert AC power received by the first input unit 44 into DC power and provide the converted DC power to the first output unit 45.

The rectification circuit 46 includes the diode D41 serving as a first rectifying element and the diode D42 serving as a second rectifying element. Each of the first rectifying element and the second rectifying element may be constituted by one or more diodes.

The first input unit 44 includes the first input terminal 441 and the second input terminal 442.

The first output unit 45 includes the first output terminal 451, the second output terminal 452, and a third output terminal 453.

An anode of the diode (first rectifying element) D41 and a cathode of the diode (second rectifying element) D42 are connected to the first input terminal 441. A cathode of the diode D41 is connected to the first output terminal 451. An anode of the diode D42 is connected to the second output terminal 452. The second input terminal 442 is connected to the third output terminal 453.

In more detail, the first power extraction circuit 4 includes a series circuit of the two diodes D41 and D42, and a single wire 43 electrically insulated from this series circuit.

Further, the diodes D41 and D42 have the same specification and have the same characteristics. Each of the diodes D41 and D42 is a silicon diode and has a forward voltage drop of about 0.6 to 0.7 V. Each of the diodes D41 and D42 is a surface-mount diode. However, each of the diodes D41 and D42 is not limited to such a surface-mount diode.

The wire 43 may be part of a patterned conductor of the aforementioned printed wiring board on which the piezoelectric vibration energy harvester 2 and the diodes D41 and D42 are to be mounted.

The connection point of the two diodes D41 and D42 and a first end of the wire 43 of the first power extraction circuit 4 are electrically connected to the piezoelectric vibration energy harvester 2 in the first connection mode, and is electrically separated from the piezoelectric vibration energy harvester 2 in the second connection mode.

The cathode of the diode D1, the anode of the further diode D2, and a second end of the wire 43 of the first power extraction circuit 4 are electrically connected to the electric storage unit 3 in the first connection mode, and is electrically separated from the electric storage unit 3 in the second connection mode.

Hereinafter, the diode D41 is referred as a first diode D41, and the other diode D42 is referred to as a second diode D42, depending on a situation.

The second power extraction circuit 5 includes a second input unit 51, a second output unit 52, and a switching circuit 56. The switching circuit 56 is between the second input unit 51 and the second output unit 52, and is configured to operate with power supplied from the electric storage 3.

The switching circuit 56 is configured to generate DC power by use of AC power received by the second input unit 51 and provide the generated DC power to the second output unit 52.

The switching circuit 56 includes the energy storage device 54, a first switch unit 53 between the second input unit 51 and the energy storage device 54, a second switch unit 55 between the second output unit 52 and the energy storage device 54.

The second input unit 51 includes the third input terminal 511 and the fourth input terminal 512.

The second output unit 52 includes the fourth output terminal 521 and the fifth output terminal 522.

The first switch unit 53 includes the first switch (first electronic analog switch) S1 between a first end of the energy storage device 54 and the third input terminal 511, a second switch (second electronic analog switch) S2 between a second end of the energy storage device 54 and the fourth input terminal 512, the third switch (third electronic analog switch) S3 between the first end of the energy storage device 54 and the fourth input terminal 512, and the fourth switch (fourth electronic analog switch) S4 between the second end of the energy storage device 54 and the third input terminal 511. Each of the switches S1 to S4 may be constituted by one or more switches.

The second switch unit 55 includes the fifth switch (fifth electronic analog switch) S5 between the first end of the energy storage device 54 and the fourth output terminal 521, and the sixth switch (sixth electronic analog switch) S6 between the second end of the energy storage device 54 and the fifth output terminal 522. Each of the switches S5 and S6 may be constituted by one or more switches.

In the present embodiment, the controller 7 functions as a control circuit of the switching circuit 56.

In other words, the controller 7 is the control circuit configured to operate with power from the electric storage 3, and configured to control the first switch unit 53 and the second switch unit 55 to convert an AC voltage received by the second input unit 51 to a DC voltage and provide the converted DC voltage to the second output unit 52.

The controller 7 is configured to, while an AC voltage to be provided to the second input unit 51 has a positive or negative polarity, perform a storing operation in which the controller 7 keeps turning off the second switch unit 55 and controls the first switch unit 53 so as to store energy in the energy storage device 54.

Concretely, the controller 7 is configured to, while an AC voltage to be provided to the second input unit 51 has a positive polarity, turn on the first switch S1 and the second switch S2 and turn off the third switch S3 and the fourth switch S4 while turning off the fifth switch S5 and the sixth switch S6, so as to perform the storing operation (first storing operation).

The controller 7 is configured to, while an AC voltage to be provided to the second input unit 51 has a negative polarity, turn on the third switch S3 and the fourth switch S4 and turn off the first switch S1 and the second switch S2 while turning off the fifth switch S5 and the sixth switch S6, so as to perform the storing operation (second storing operation).

Note that, the controller 7 may be configured to: perform the first storing operation while an AC voltage to be provided to the second input unit 51 has a negative polarity; and perform the second storing operation while an AC voltage to be provided to the second input unit 51 has a positive polarity.

The controller 7 is configured to, when an AC voltage to be provided to the second input unit 51 becomes zero, start a discharging operation in which the controller 7 turns off the first switch unit 53 and turns on the second switch unit 55 so as to allow the energy storage device 54 to provide a DC voltage to the second output unit 52. In the present embodiment, the controller 7 is configured to start the discharging operation when the displacement of the movable portion 22 from the basic position measured by the displacement measurement sensor 8 becomes zero.

Concretely, the controller 7 is configured to, when an AC voltage to be provided to the second input unit 51 becomes zero, turn off the first switch S1, the second switch S2, the third switch S3, and the fourth switch S4 and turn on the fifth switch S5 and the sixth switch S6, so as to perform the discharging operation.

In more detail, the second power extraction circuit 5 includes a pair of the input terminals 511 and 512 and a pair of the output terminals 521 and 522.

The second power extraction circuit 5 includes a series circuit of the first electronic analog switch S1, the energy storage device 54, and the second electronic analog switch S2, and this series circuit is between the input terminal 511 and the further input terminal 512.

The energy storage device 54 is an inductor. The energy storage device 54 may be constituted by one or more inductors.

The second power extraction circuit 5 includes the third electronic analog switch S3 between the connection point of the first electronic analog switch S1 and the energy storage device 54 and the further input terminal 512.

The second power extraction circuit 5 includes the fourth electronic analog switch S4 between the connection point of the energy storage device 54 and the second electronic analog switch S2 and the input terminal 511.

The second power extraction circuit 5 includes the fifth electronic analog switch S5 between the connection point of the first electronic analog switch S1 and the energy storage device 54 and the output terminal 521.

The second power extraction circuit 5 includes the sixth electronic analog switch S6 between the connection point of the energy storage device 54 and the second electronic analog switch S2 and the further output terminal 522.

The first to sixth electronic analog switches S1 to S6 are turned on and off by the controller 7 in the second connection mode.

In is preferable that each of the first to sixth electronic analog switches S1 to S6 be an n-channel MOS transistor. In this case, compared with each of the first to sixth electronic analog switches S1 to S6 constituted by a p-channel MOS transistor, each of the first to sixth electronic analog switches S1 to S6 can have a lowered on-resistance and operate rapidly. Each of the first to sixth electronic analog switches S1 to S6 is preferably a normally-off switch.

The switch circuit 6 has: the first connection mode of connecting the electric generator 2 and the electric storage 3 to the first input unit 44 and the first output unit 45, respectively; and the second connection mode of connecting the electric generator 2 and the electric storage 3 to the second input unit 51 and the second output unit 52, respectively. In other words, according to the first connection mode, the first power extraction circuit 4 is interposed between the electric generator 2 and the electric storage 3. According to the second connection mode, the second power extraction circuit 5 is interposed between the electric generator 2 and the electric storage 3.

The switch circuit 6 is configured to, in the first connection mode, connect the two or more electric generation portions 24 to the first input unit 44 such that an effective value of an AC voltage to be provided to the first input unit 44 in the first connection mode is greater than an effective value of an AC voltage to be provided to the second input unit 51 in the second connection mode.

The switch circuit 6 is configured to, in the second connection mode, connect the two or more electric generation portions 24 to the second input unit 51 such that the effective value of the AC voltage to be provided to the second input unit 51 in the second connection mode is greater than the effective value of the AC voltage to be provided to the first input unit 44 in the first connection mode.

The switch circuit 6 is configured to, in the first connection mode, make a series circuit of the two or more electric generation portions 24 and connect the series circuit to the first input unit 44, and is configured to, in the second connection mode, make a parallel circuit of the two or more electric generation portions 24 and connect the parallel circuit to the second input unit 51.

The switch circuit 6 is configured to, in the first connection mode, connect the two or more electric generation portions 24 in series between the first input terminal 441 and the second input terminal 442, connect the first capacitive element (capacitor) C31 and the second capacitive element (capacitor) C32 in series between the first output terminal 451 and the second output terminal 452, and connect the third output terminal 453 to the connection point of the first capacitive element C31 and the second capacitive element C32.

The switch circuit 6 is configured to, in the second connection mode, connect the two or more electric generation portions 24 in parallel between the third input terminal 511 and the fourth input terminal 512 and connect the electric storage 3 between the fourth output terminal 521 and the fifth output terminal 522.

In the present embodiment, the switch circuit 6 includes: at least one first switch device Q1 (Q11, Q12, Q13, and Q14) between the electric generator 2 and the first input unit 44; at least one second switch device Q2 (Q21, Q22, and Q23) between the electric storage 3 and the first output unit 45; at least one third switch device Q3 (Q31, Q32, and Q33) between the electric generator 2 and the second input unit 51, and at least one fourth switch device Q4 (Q41 and Q42) between the electric storage 3 and the second output unit 52. Each of the first switch device Q1 and the second switch device Q2 is a normally-on switch. Each of the third switch device Q3 and the fourth switch device Q4 is a normally-off switch. Each of the switch devices Q1 to Q4 may be constituted by one or more switches.

In more detail, the switch circuit 6 includes the first switch device Q1 interposed between the piezoelectric vibration energy harvester 2 and the first power extraction circuit 4, the second switch device Q2 interposed between the first power extraction circuit 4 and the electric storage unit 3, the third switch device Q3 interposed between the piezoelectric vibration energy harvester 2 and the second power extraction circuit 5, and the fourth switch device Q4 interposed between the piezoelectric vibration energy harvester 2 and the electric storage unit 3.

To enable connection of a series circuit of all the electric generation portions 24 of the piezoelectric vibration energy harvester 2 to the first power extraction circuit 4, the switch circuit 6 includes the four first switch devices Q1 (Q11, Q12, Q13, and Q14).

The first switch device Q11 is interposed between the first pad 25 of the electric generation portion 24A and the first input terminal 441 of the first input unit 44.

The first switch device Q12 is interposed between the second pad 25 of the electric generation portion 24A and the first pad 25 of the electric generation portion 24B.

The first switch device Q13 is interposed between the second pad 25 of the electric generation portion 24B and the first pad 25 of the electric generation portion 24C.

The first switch device Q14 is interposed between the second pad 25 of the electric generation portion 24C and the second input terminal 442 of the first input unit 44.

In summary, the switch circuit 6 includes the two first switch devices Q1 (Q12 and Q13) connected between the pads 25 and 25 with different polarities of the different electric generation portions 24 to be connected in series with each other. The switch circuit 6 includes the two first switch devices Q1 (Q11 and Q14). One of the two first switch devices Q1 (Q11 and Q14) is provided between one of the pads 25 and 25 at the opposite ends of the series circuit of all the electric generation portions and one of the input terminals 441 and 442 of the first power extraction circuit 4, and the other the two first switch devices Q1 (Q11 and Q14) is provided between the other of the pads 25 and 25 at the opposite ends of the series circuit of all the electric generation portions and the other of the input terminals 441 and 442 of the first power extraction circuit 4.

Further, to enable connection of a parallel circuit of all the electric generation portions 24 of the piezoelectric vibration energy harvester 2 to the second power extraction circuit 5, the switch circuit 6 includes the total six third switch devices Q3 (Q31, Q32, and Q33).

One of the third switch devices Q31 is interposed between the third input terminal 511 of the second input unit 51 and one of the pads 25 of the electric generation portion 24A, and the other of the third switch devices Q31 is interposed between the fourth input terminal 512 of the second input unit 51 and the other of the pads 25 of the electric generation portion 24A.

One of the third switch devices Q32 is interposed between the third input terminal 511 of the second input unit 51 and one of the pads 25 of the electric generation portion 24B, and the other of the third switch devices Q32 is interposed between the fourth input terminal 512 of the second input unit 51 and the other of the pads 25 of the electric generation portion 24B.

One of the third switch devices Q33 is interposed between the third input terminal 511 of the second input unit 51 and one of the pads 25 of the electric generation portion 24C, and the other of the third switch devices Q33 is interposed between the fourth input terminal 512 of the second input unit 51 and the other of the pads 25 of the electric generation portion 24C.

In summary, the switch circuit 6 includes the total six third switch devices Q3 including the pair of the third switch devices Q3 individually interposed between the input terminals 511 and 512 of the second power extraction circuit 5 and the pads 25 and 25 with different polarities for each of all the electric generation portions 24 to be connected in parallel with each other.

Further, to enable connection between the first power extraction circuit 4 and the electric storage unit 3, the switch circuit 6 includes the three second switch devices Q2 (Q21, Q22, and Q23).

The second switch device Q21 is interposed between the first output terminal 451 of the first output unit 45 and the first power terminal 33 of the electric storage 3.

The second switch device Q22 is interposed between the second output terminal 452 of the first output unit 45 and the second power terminal 34 of the electric storage 3.

The second switch device Q23 is interposed between the third output terminal 453 of the first output unit 45 and the ground terminal 35 of the electric storage 3.

In summary, the switch circuit 6 includes the three second switch devices Q2. One of the three second switch devices Q2 is interposed between the cathode of the first diode D41 of the first power extraction circuit 4 and the first end of the first capacitor C31, another of the three second switch devices Q2 is interposed between the second end of the wire 43 and the connection point of the second end of the first capacitor C31 and the first end of the second capacitor C32, and the other of the three second switch devices Q2 is interposed between the anode of the second diode D42 and the second end of the second capacitor C32.

Further, to enable connection between the second power extraction circuit 5 and the electric storage unit 3, the switch circuit 6 includes the two fourth switch devices Q4 (Q41 and Q42).

The fourth switch device Q41 is interposed between the fourth output terminal 521 of the second output unit 52 and the first power terminal 33 of the electric storage 3.

The fourth switch device Q42 is interposed between the fifth output terminal 522 of the second output unit 52 and the second power terminal 34 of the electric storage 3.

In summary, the switch circuit 6 includes the two fourth switch devices Q4 interposed between the output terminals of the second power extraction circuit 5 and the ends of the electric storage unit 3 individually.

In the switch circuit 6, it is preferable that each of the first switch device Q1 and the second switch device Q2 be a normally-on switch and each of the third switch device Q3 and the fourth switch device Q4 be a normally-off switch.

According to this configuration, even if the electric storage unit 3 fails to supply a voltage not less than the minimum operating voltage of the controller 7 to the controller 7 and the controller 7 is not in operation, the energy harvesting device 1 can have the first connection mode. Thus, the energy harvesting device 1 can charge the electric storage unit 3 with electricity from the piezoelectric vibration energy harvester 2.

In other words, the switch circuit 6 is configured to be in the first connection mode while the output voltage of the electric storage 3 is less than the predetermined voltage.

Even in an initial state in which the electric storage unit 3 is not charged, the energy harvesting device 1 can charge the electric storage unit 3 with electricity from the piezoelectric vibration energy harvester 2 without using an external power source.

It is preferable that each of the first switch device Q1 and the second switch device Q2 be constituted by a normally-on MOS transistor. Each of the first switch device Q1 and the second switch device Q2 is not limited thereto. For example, each of the first switch device Q1 and the second switch device Q2 may be constituted by a contact (break contact) of a normally-on relay.

It is preferable that each of the third switch device Q3 and the fourth switch device Q4 be constituted by a normally-off MOS transistor. Each of the third switch device Q3 and the fourth switch device Q4 is not limited thereto. For example, each of the third switch device Q3 and the fourth switch device Q4 may be constituted by a contact (make contact) of a normally-off relay.

The numbers of first switch devices Q1, second switch devices Q2, third switch devices Q3, and fourth switch devices Q4 are not limited particularly. It is necessary to appropriately determine the numbers of first switch devices Q1 and third switch devices Q3 based on the number of electric generation portions 24 of the piezoelectric vibration energy harvester 2.

The first switch device Q1 and the third switch device Q3 of the aforementioned switch circuit 6 constitute a first switching unit 6a provided between the piezoelectric vibration energy harvester 2 and the first power extraction circuit 4 as well as the second power extraction circuit 5.

Further, the second switch device Q2 and the fourth switch device Q4 of the switch circuit 6 constitute a second switching unit 6b provided between the electric storage unit 3 and the first power extraction circuit 4 as well as the second power extraction circuit 5.

In the first connection mode of the energy harvesting device 1, the connection point of the two diodes D41 and D42 is connected to one of output ends of the piezoelectric vibration energy harvester 2 and the connection point of the two capacitors C31 and C32 is connected to the other of the output ends of the piezoelectric vibration energy harvester 2.

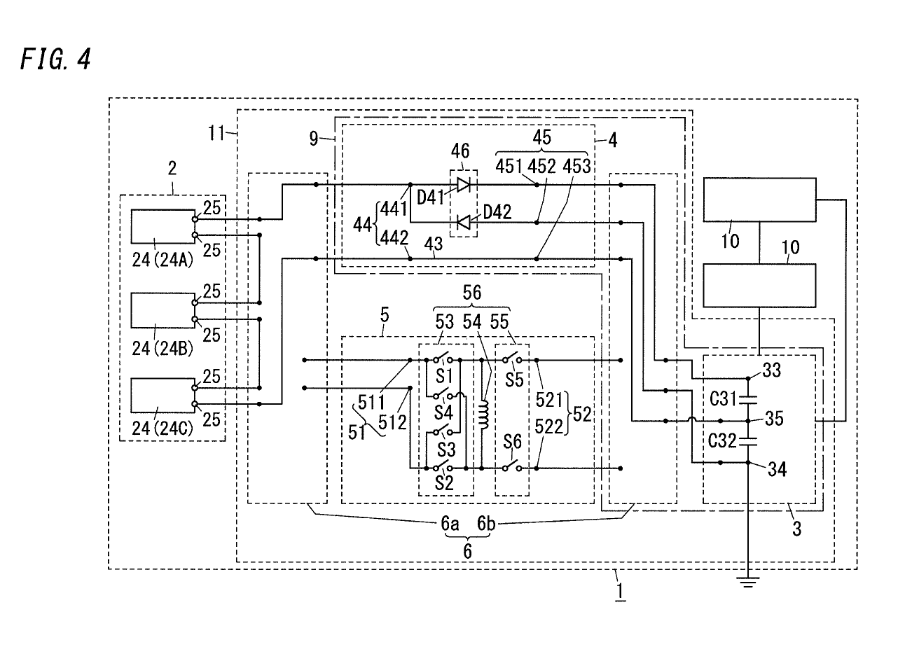

In other words, in the first connection mode, the energy harvesting device 1 has a full-wave voltage doubler 9 configured to perform voltage doubler rectification on an AC voltage generated by the piezoelectric vibration energy harvester 2 (see FIG. 4).

In this full-wave voltage doubler 9, the series circuit of the two diodes D41 and D42 is connected in parallel with the series circuit of the two capacitors C31 and C32. In brief, the full-wave voltage doubler 9 includes a bridge circuit of the two diodes D41 and D42 and the two capacitors C31 and C32.

The following explanation referring to FIG. 4 is made to the operation of the energy harvesting device 1 in the first connection mode. FIG. 4 does not show the controller 7.

In the first connection mode, as shown in FIG. 4, the piezoelectric vibration energy harvester 2 and the electric storage unit 3 are electrically connected to the first power extraction circuit 4, and are electrically separated (electrically insulated) from the second power extraction circuit 5.

The operation in a positive half cycle is described first. In the positive half cycle, one of the output ends (the first pad 25 of the electric generation portion 24) of the piezoelectric vibration energy harvester 2 is higher in electric potential than the other of the output ends (the second pad 25 of the electric generation portion 24).

The energy harvesting device 1 connects the series circuit of all the electric generation portions 24 of the piezoelectric vibration energy harvester 2 to the first power extraction circuit 4, and the input terminal 441 of the first power extraction circuit 4 has an electric potential higher than an electric potential of the further input terminal 442 of the first power extraction circuit 4. Thus, a current supplied from the piezoelectric vibration energy harvester 2, flows through the diode D41, the capacitor C31, and the wire 43, and returns to the piezoelectric vibration energy harvester 2. Consequently, the capacitor C31 is charged.

Next, the operation in a negative half cycle is described. In the negative half cycle, one of the output ends (the first pad 25 of the electric generation portion 24) of the piezoelectric vibration energy harvester 2 is lower in electric potential than the other of the output ends (the second pad 25 of the electric generation portion 24).

In the energy harvesting device 1, the input terminal 441 of the first power extraction circuit 4 has an electric potential lower than an electric potential of the further input terminal 442 of the first power extraction circuit 4. Thus, a current supplied from the piezoelectric vibration energy harvester 2, flows through the wire 43, the capacitor C32, and the diode D42, and returns to the piezoelectric vibration energy harvester 2. Consequently, the capacitor C32 is charged.

In short, the full-wave voltage doubler 9 charges the capacitor C31 in one of the half cycles of the waveform of the output voltage of the piezoelectric vibration energy harvester 2, and charges the other capacitor C32 in the other of the half cycles. Thus, the voltage across the electric storage unit 3 (i.e., the output voltage of the energy harvesting device 1) is about twice as high as the peak value of the output voltage of the piezoelectric vibration energy harvester 2.

In the energy harvesting device 1, the full-wave voltage doubler 9 is formed in the first connection mode. In contrast to a prior full-wave rectifier constituted by a bridge circuit of the four diodes D1, D2, D3, and D4, it is possible to reduce a voltage loss (forward voltage drop) caused by a circuit connected to an input side of the electric storage unit 3. Hence, it is possible to downsize the energy harvesting device 1 and to increase the output of the energy harvesting device 1.

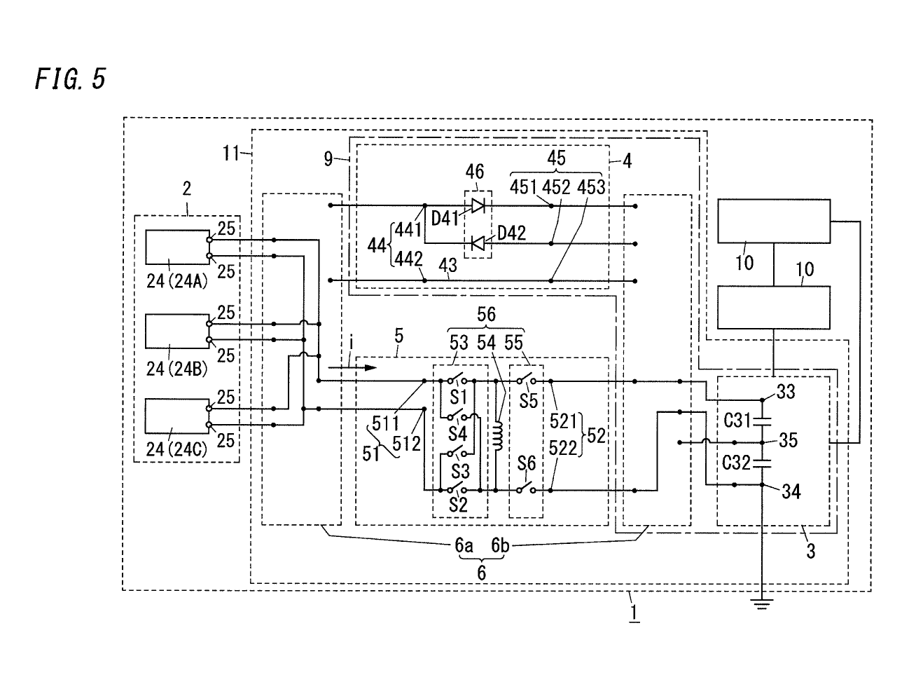

The following explanation referring to FIGS. 5 to 8 is made to the operation of the energy harvesting device 1 in the second connection mode. FIGS. 5 to 8 do not show the controller 7.

In the second connection mode, as shown in FIG. 5, the piezoelectric vibration energy harvester 2 and the electric storage unit 3 are electrically connected to the second power extraction circuit 5, and are electrically separated (electrically insulated) from the first power extraction circuit 4.

In this case, a parallel circuit of all the electric generation portions 24 (24A, 24B, and 24C) of the piezoelectric vibration energy harvester 2 is connected between the pair of the input terminals 511 and 512 of the second power extraction circuit 5.

Further, in the second connection mode, the first to sixth electronic analog switches S1 to S6 of the second power extraction circuit 5 are turned on and off by the controller 7 as described above.

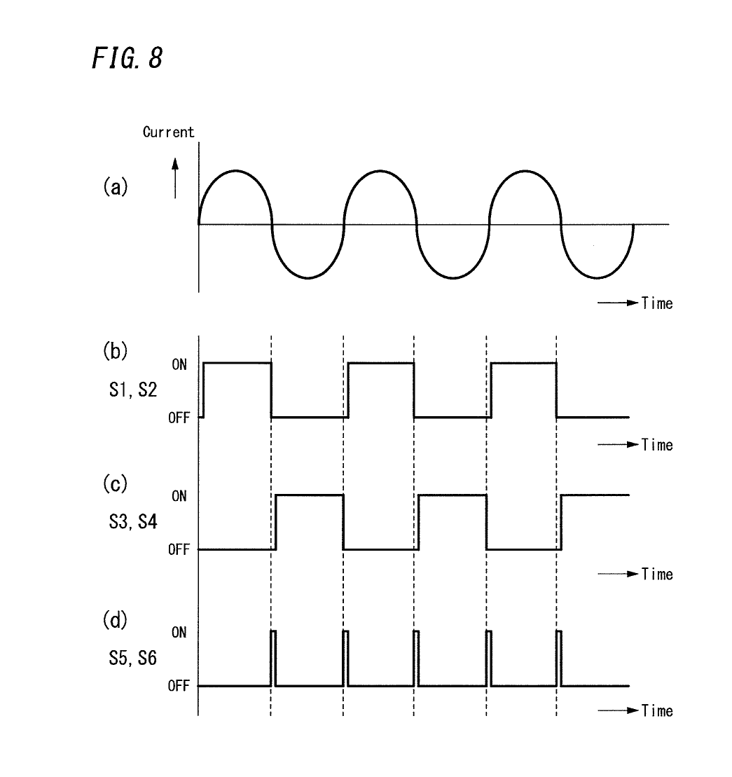

FIG. 8(a) shows a waveform of a current “i” (see FIG. 5) that flows from the piezoelectric vibration energy harvester 2 to the second power extraction circuit 5. A direction of a flow of the current “i” from the piezoelectric vibration energy harvester 2 toward one input terminal 511 is treated as a positive direction. The waveform of the current “i” is sinusoidal, and the displacement measurement sensor 8 outputs a sine-wave AC signal substantially synchronized with the waveform of this current “i”.

FIG. 8(b) shows the ON and OFF states of the first and second electronic analog switches S1 and S2. FIG. 8(c) shows the ON and OFF states of the third and fourth electronic analog switches S3 and S4. FIG. 8(d) shows the ON and OFF states of the fifth and sixth electronic analog switches S5 and S6.

The operation in the positive half cycle is described first. In the positive half cycle, one of the output ends (the first pad 25 of the electric generation portion 24) of the piezoelectric vibration energy harvester 2 is higher in electric potential than the other of the output ends (the second pad 25 of the electric generation portion 24).

In the energy harvesting device 1, the input terminal 511 of the second power extraction circuit 5 has an electric potential higher than an electric potential of the further input terminal 512 of the second power extraction circuit 5.

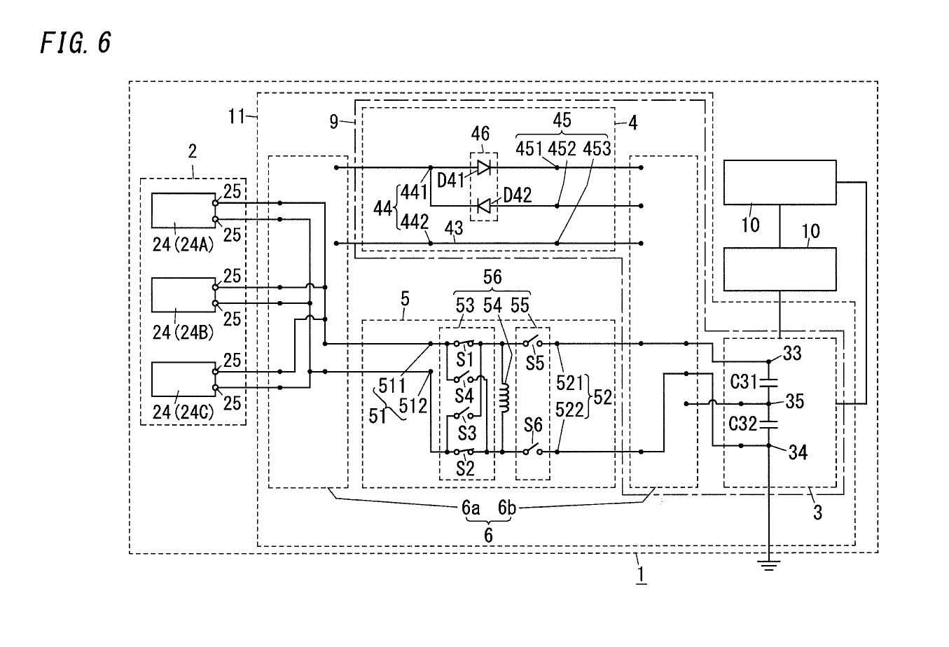

The controller 7 controls the second power extraction circuit 5 so as to turn on the first and second electronic analog switches S1 and S2 and turn off the third to sixth electronic analog switches S3 to S6 (FIG. 6 shows an equivalent circuit of the second power extraction circuit 5 controlled by the controller 7 in this manner). Thus, the controller 7 performs the first storing operation.

The energy harvesting device 1 supplies the current “i” to the energy storage device 54 constituted by the inductor, and therefore energy is stored in the energy storage device 54.

Next, the operation in the negative half cycle is described. In the negative half cycle, one of the output ends (the first pad 25 of the electric generation portion 24) of the piezoelectric vibration energy harvester 2 is lower in electric potential than the other of the output ends (the second pad 25 of the electric generation portion 24).

The controller 7 functions to detect the zero crossing of the AC signal from the displacement measurement sensor 8. First, the controller 7 controls the second power extraction circuit 5 so as to, in synchronization with the zero crossing of the AC signal from the displacement measurement sensor 8, turn on the fifth and sixth electronic analog switches S5 and S6 and turn off the first to fourth electronic analog switches S1 to S4. Thus, the controller 7 performs the discharging operation.

Accordingly, the energy harvesting device 1 discharges energy stored in the energy storage device 54 and charges the electric storage unit 3 with this discharged energy.

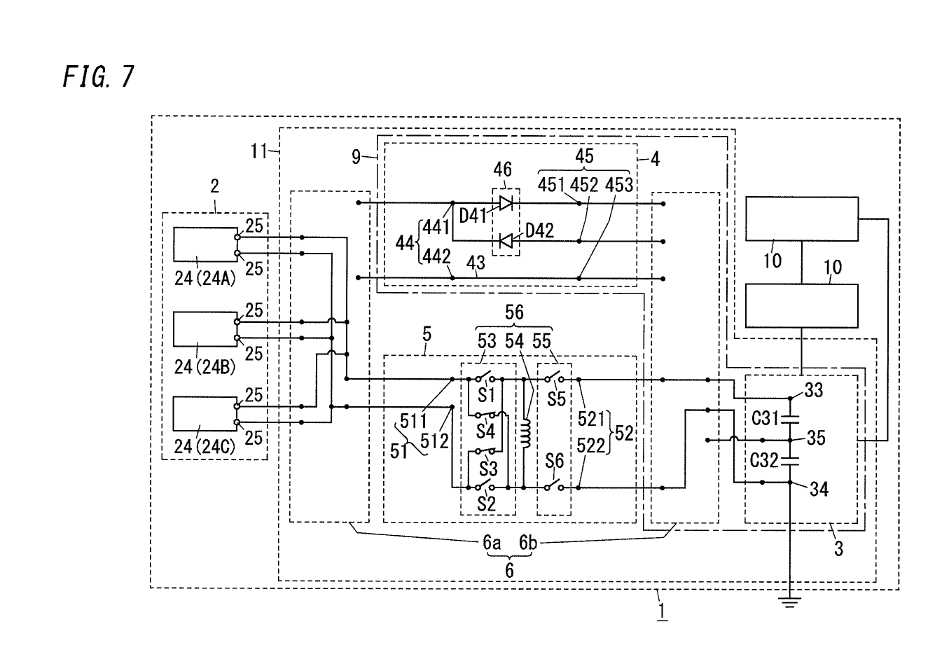

Thereafter, the controller 7 controls the second power extraction circuit 5 so as to turn on the third and fourth electronic analog switches S3 and S4 and turn off the first, second, fifth and sixth electronic analog switches S1, S2, S5, and S6 (FIG. 7 shows an equivalent circuit of the second power extraction circuit 5 controlled by the controller 7 in this manner). Thus, the controller 7 performs the second storing operation.

The energy harvesting device 1 supplies the current “i” to the energy storage device 54 constituted by the inductor, and therefore energy is stored in the energy storage device 54.

Thereafter, when, in the positive half cycle, one of the output ends (the first pad 25 of the electric generation portion 24) of the piezoelectric vibration energy harvester 2 is higher in electric potential than the other of the output ends (the second pad 25 of the electric generation portion 24), the controller 7 controls the second power extraction circuit 5 so as to, in synchronization with the zero crossing of the AC signal from the displacement measurement sensor 8, turn on the fifth and sixth electronic analog switches S5 and S6 and turn off the first to fourth electronic analog switches S1 to S4. Thus, the controller 7 performs the discharging operation.

Accordingly, the energy harvesting device 1 discharges energy stored in the energy storage device 54 and charges the electric storage unit 3 with this discharged energy.

Subsequently, as described above, the controller 7 controls the second power extraction circuit 5 so as to turn on the first and second electronic analog switches S1 and S2 and turn off the third to sixth electronic analog switches S3 to S6 (FIG. 6 shows an equivalent circuit of the second power extraction circuit 5 controlled by the controller 7 in this manner). Thus, the controller 7 performs the first storing operation again.

The second power extraction circuit 5 repeats storing energy in the aforementioned energy storage device 54 and discharging energy from the energy storage device 54. In short, the controller 7 performs the storing operation and the discharging operation alternately.

The energy harvesting device 1 of the present embodiment described above includes the piezoelectric vibration energy harvester 2, the first power extraction circuit 4, and the second power extraction circuit 5. The piezoelectric vibration energy harvester 2 includes two or more electric generation portions 24. The first power extraction circuit 4 is constituted by the two diodes D41 and D42. The second power extraction circuit 5 is constituted by the electronic analog switches S1 to S6 and the energy storage device 54. Further, the energy harvesting device 1 includes the switch circuit 6 and the controller 7. The switch circuit 6 is configured to switch between the first connection mode and the second connection mode selectively. The controller 7 is configured to operate on electricity from the electric storage unit 3 and to control the second power extraction circuit 5 and the switch circuit 6. The switch circuit 6 is configured to, in the first connection mode, connect the series circuit of the two or more electric generation portions 24 between the input terminals of the first power extraction circuit 4 and connect the electric storage unit 3 between the output terminals of the first power extraction circuit 4. The switch circuit 6 is configured to, in the second connection mode, connect the parallel circuit of the two or more electric generation portions 24 between the input terminals of the second power extraction circuit 5 and connect the electric storage unit 3 between the output terminals of the second power extraction circuit 5.

In other words, the energy harvesting device of the present embodiment includes: the electric generator (piezoelectric vibration energy harvester) 2 for charging the electric storage (electric storage unit) 3; and the power management circuit 11 configured to operate with power from the electric storage 3, and to charge the electric storage 3 with power from the electric generator 2. The electric generator 2 includes the two or more electric generation portions 24 each configured to generate AC power when vibrated. The power management circuit 11 includes the first power extraction circuit 4, the second power extraction circuit 5, and the switch circuit 6. The first power extraction circuit 4 includes the first input unit 44, the first output unit 45, and the rectification circuit 46 between the first input unit 44 and the first output unit 45. The rectification circuit 46 is configured to convert AC power received by the first input unit 44 into DC power and provide the converted DC power to the first output unit 45. The second power extraction circuit 5 includes the second input unit 51, the second output unit 52, and the switching circuit 56. The switching circuit 56 is between the second input unit 51 and the second output unit 52 and is configured to operate with power supplied from the electric storage 3. The switching circuit 56 is configured to generate DC power by use of AC power received by the second input unit 51 and provide the generated DC power to the second output unit 52. The switch circuit 6 has the first connection mode of connecting the electric generator 2 and the electric storage 3 to the first input unit 44 and the first output unit 45, respectively, and the second connection mode of connecting the electric generator 2 and the electric storage 3 to the second input unit 51 and the second output unit 52, respectively. The switch circuit 6 is configured to, in the first connection mode, connect the two or more electric generation portions 24 to the first input unit 44 such that the effective value of the AC voltage to be provided to the first input unit 44 in the first connection mode is greater than the effective value of the AC voltage to be provided to the second input unit 51 in the second connection mode. The switch circuit 6 is configured to, in the second connection mode, connect the two or more electric generation portions 24 to the second input unit 51 such that the effective value of the AC voltage to be provided to the second input unit 51 in the second connection mode is greater than the effective value of the AC voltage to be provided to the first input unit 44 in the first connection mode.

Further, the switch circuit 6 of the energy harvesting device 1 is configured to, in the first connection mode, make the series circuit of the two or more electric generation portions 24 and connect the series circuit to the first input unit 44, and is configured to, in the second connection mode, make the parallel circuit of the two or more electric generation portions 24 and connect the parallel circuit to the second input unit 51. Note that, this configuration is optional.

The energy harvesting device 1 further includes the electric storage 3. Note that, this configuration is optional.

Accordingly, in the energy harvesting device 1 of the present embodiment, the controller 7 controls the switch circuit 6. It is possible to charge the electric storage unit 3 efficiently. In short, the energy harvesting device 1 of the present embodiment can charge the electric storage unit 3 efficiently.

In this energy harvesting device 1, it is preferable that, when the output voltage of the electric storage unit 3 is higher than the minimum operating voltages of the controller 7 and the second power extraction circuit 5, the controller 7 switch the switch circuit 6 to the second connection mode.

In other words, in the energy harvesting device 1, the power management circuit 11 includes the controller 7 configured to operate with power from the electric storage 3. The controller 7 is configured to, when the output voltage of the electric storage 3 is not less than the predetermined voltage, switch the switch circuit 6 from the first connection mode to the second connection mode. Note that, this configuration is optional.

In this energy harvesting device 1, the predetermined voltage is the minimum operating voltage of the power management circuit 11. Note that, this configuration is optional.

In this energy harvesting device 1, the minimum operating voltage of the power management circuit 11 is not less than the minimum operating voltage of the second power extraction circuit 5 and also is not less than the minimum operating voltage of the controller 7. Note that, this configuration is optional.

Accordingly, the energy harvesting device 1 can efficiently extract generation power from the piezoelectric vibration energy harvester 2 and charge the electric storage unit 3 with the extracted generation power. Note that, the minimum operating voltages of the controller 7 and the second power extraction circuit 5 may be different voltages or the same voltage.

In this energy harvesting device 1, it is preferable that the switch circuit 6 includes the aforementioned first to fourth switch devices Q1 to Q4 and each of the first switch device Q1 and the second switch device Q2 is a normally-on switch and each of the third switch device Q3 and the fourth switch device Q4 is a normally-off switch. In this case, the first switch device Q1 is interposed between the piezoelectric vibration energy harvester 2 and the first power extraction circuit 4. The second switch device Q2 is interposed between the first power extraction circuit 4 and the electric storage unit 3. The third switch device Q3 is interposed between the piezoelectric vibration energy harvester 2 and the second power extraction circuit 5. The fourth switch device Q4 is interposed between the piezoelectric vibration energy harvester 2 and the electric storage unit 3.

In other words, the switch circuit 6 is configured to be in the first connection mode while the output voltage of the electric storage is less than the predetermined voltage. Note that, this configuration is optional.

Especially, the switch circuit 6 includes: the first switch device Q1 between the electric generator 2 and the first input unit 44; the second switch device Q2 between the electric storage 3 and the first output unit 45; the third switch device Q3 between the electric generator 2 and the second input unit 51; and the fourth switch device Q4 between the electric storage 3 and the second output unit 52. Each of the first switch device Q1 and the second switch device Q2 is a normally-on switch. Each of the third switch device Q3 and the fourth switch device Q4 is a normally-off switch. Note that, this configuration is optional.

Accordingly, when the output voltage of the electric storage unit 3 is less than the minimum operating voltages of the controller 7 and the second power extraction circuit 5, the energy harvesting device 1 connects the piezoelectric vibration energy harvester 2 to the first power extraction circuit 4. Thus, the energy harvesting device 1 can extract the generation power from the piezoelectric vibration energy harvester 2 and charge the electric storage unit 3 with the extracted generation power. In short, even when the output voltage of the electric storage unit 3 is 0 V or is less than the minimum operating voltages temporarily, the energy harvesting device 1 can extract the generation power from the piezoelectric vibration energy harvester 2 by use of the first power extraction circuit 4 and charge the electric storage unit 3 with the extracted generation power.

In the energy harvesting device 1, the electric storage unit 3 is constituted by the series circuit of the two capacitors C31 and C32. The first power extraction circuit 4 is constituted by the series circuit of the two diodes D41 and D42. In the first connection mode, the connection point of the two diodes D41 and D42 is connected to the output end of the piezoelectric vibration energy harvester 2 (the first pad 25 of the electric generation portion 24) and the connection point of the two capacitors C31 and C32 is connected to the further output end of the piezoelectric vibration energy harvester 2 (the second pad 25 of the electric generation portion 24). Thereby, the full-wave voltage doubler 9 configured to voltage doubler rectification on the AC voltage generated by the piezoelectric vibration energy harvester 2 is formed.

In other words, in the energy harvesting device 1, the electric storage 3 includes the first capacitive element (capacitor C31) and the second capacitive element (capacitor C32). The rectification circuit 46 includes the first rectifying element (diode D41) and the second rectifying element (diode D42). The first input unit 44 includes the first input terminal 441 and the second input terminal 442. The first output unit 45 includes the first output terminal 451, the second output terminal 452, and the third output terminal 453. The anode of the first rectifying element (diode D41) and the cathode of the second rectifying element (diode D42) are connected to the first input terminal 441. The cathode of the first rectifying element (diode D41) is connected to the first output terminal 451. The anode of the second rectifying element (diode D42) is connected to the second output terminal 452. The second input terminal 442 is connected to the third output terminal 453. The switch circuit 6 is configured to, in the first connection mode, connect the two or more electric generation portions 24 in series between the first input terminal 441 and the second input terminal 442, connect the first capacitive element (capacitor C31) and the second capacitive element (capacitor C32) in series between the first output terminal 451 and the second output terminal 452, and connect the third output terminal 453 to the connection point (ground terminal) 35 of the first capacitive element (capacitor C31) and the second capacitive element (capacitor C32). Note that, this configuration is optional.

Accordingly, the energy harvesting device 1 can increase the voltage of the electric storage unit 3 in the first connection mode. Note that, the energy harvesting device 1 may form a circuit different from the full-wave voltage doubler 9 in the first connection mode.

In a preferred embodiment of the energy harvesting device 1, as described above, the piezoelectric vibration energy harvester 2 includes the supporting portion 21 and the movable portion 22. The movable portion 22 is swingably supported by the supporting portion 21 and vibrates in response to an environmental vibration. The two or more electric generation portions 24 are on the movable portion 22.

In the energy harvesting device 1, the two or more electric generation portions 24 are provided to the same movable portion in the piezoelectric vibration energy harvester 2 of the single chip. It is possible to avoid an unwanted situation where the outputs of the electric generation portions 24 have different amplitudes and different phases. According to the energy harvesting device 1, it is possible to downsize the piezoelectric vibration energy harvester 2 and increase the output of the piezoelectric vibration energy harvester 2, in contrast to an instance where the two or more electric generation portions 24 are on different chips.

In a preferred embodiment of the energy harvesting device 1, the energy harvesting device 1 further includes the displacement measurement sensor 8. The displacement measurement sensor 8 is configured to determine the displacement of the movable portion 22. The controller 7 turns on and off the electronic analog switches S1 to S6 of the second power extraction circuit 5 at near the zero crossing of the AC signal from the displacement measurement sensor 8.

Accordingly, the controller 7 of the energy harvesting device 1 can indirectly and accurately detect the zero crossing of the AC current caused by the AC voltage generated by the piezoelectric vibration energy harvester 2, based on the AC signal outputted from the displacement measurement sensor 8. Hence, the energy harvesting device 1 can efficiently extract the generation power from the piezoelectric vibration energy harvester 2 in the second connection mode. Therefore, the energy harvesting device 1 can efficiently charge the electric storage unit 3.

In other words, the second power extraction circuit 5 of the energy harvesting device 1 includes: the energy storage device 54;
the first switch unit 53 between the second input unit 51 and the energy storage device 54, the second switch unit 55 between the second output unit 52 and the energy storage device 54, and the control circuit (controller 7). The control circuit (controller 7) is configured to operate with power from the electric storage 3, and configured to control the first switch unit 53 and the second switch unit 55 to convert the AC voltage received by the second input unit 51 to the DC voltage and provide the converted DC voltage to the second output unit 52. Note that, this configuration is optional.

In particular, the control circuit (controller 7) of the energy harvesting device 1 is configured to, while the AC voltage to be provided to the second input unit 51 has the positive or negative polarity, perform the storing operation in which the control circuit (controller 7) keeps turning off the second switch unit 55 and controls the first switch unit 53 so as to store energy in the energy storage device 54. The control circuit (controller 7) is configured to, when the AC voltage to be provided to the second input unit 51 becomes zero, start the discharging operation in which the control circuit (controller 7) turns off the first switch unit 53 and turns on the second switch unit 55 so as to allow the energy storage device 54 to provide the DC voltage to the second output unit 52. Note that, this configuration is optional.

Especially, in the energy harvesting device 1, the second input unit 51 includes the third input terminal 511 and the fourth input terminal 512. The second output unit 52 includes the fourth output terminal 521 and the fifth output terminal 522. The first switch unit 53 includes the first switch S1 between the first end of the energy storage device 54 and the third input terminal 511, the second switch S2 between the second end of the energy storage device 54 and the fourth input terminal 512, the third switch S3 between the first end of the energy storage device 54 and the fourth input terminal 512, and the fourth switch S4 between the second end of the energy storage device 54 and the third input terminal 511. The second switch unit 55 includes the fifth switch S5 between the first end of the energy storage device 54 and the fourth output terminal 521, and the sixth switch S6 between the second end of the energy storage device 54 and the fifth output terminal 522. The switch circuit 6 is configured to, in the second connection mode, connect the two or more electric generation portions 24 in parallel between the third input terminal 511 and the fourth input terminal 512 and connect the electric storage 3 between the fourth output terminal 521 and the fifth output terminal 522. The control circuit (controller 7) is configured to: while the AC voltage to be provided to the second input unit 51 has one of the positive polarity and the negative polarity, turn on the first switch S1 and the second switch S2 and turn off the third switch S3 and the fourth switch S4 while turning off the fifth switch S5 and the sixth switch S6, so as to perform the storing operation; and while the AC voltage to be provided to the second input unit 51 has the other of the positive polarity and the negative polarity, turn off the first switch S1 and the second switch S2 and turn on the third switch S3 and the fourth switch S4 while turning off the fifth switch S5 and the sixth switch S6, so as to perform the storing operation. The control circuit (controller 7) is configured to, when the AC voltage to be provided to the second input unit 51 becomes zero, turn off the first switch S1, the second switch S2, the third switch S3, and the fourth switch S4 and turn on the fifth switch S5 and the sixth switch S6, so as to perform the discharging operation. Note that, this configuration is optional.

Specifically, the energy harvesting device 1 further includes the displacement measurement sensor 8. The electric generator 2 includes the movable portion 22 which is movable from the basic position in response to a vibration given to the movable portion 22. The two or more electric generation portions 24 are provided to the movable portion 22, and each configured to generate AC power depending on the displacement of the movable portion 22 from the basic position. The displacement measurement sensor 8 is configured to measure the displacement of the movable portion 22 from the basic position. The control circuit (controller 7) is configured to, when the displacement of the movable portion 22 from the basic position measured by the displacement measurement sensor 8 becomes zero, start the discharging operation. Not that, this configuration is optional.

Notably, the displacement measurement sensor 8 of the energy harvesting device 1 is a capacitance displacement measurement sensor. Note that, this configuration is optional.

Besides, the controller 7 may turn on and off the electronic analog switches S1 to S6 of the second power extraction circuit 5 depending on an output from a sensor (e.g., a current transformer) configured to detect a current flowing through the second power extraction circuit 5, as an alternative to the AC signal outputted from the displacement measurement sensor 8.

In short, the energy harvesting device 1 further includes a current measurement device (e.g., a current transformer). The current measurement device is configured to measure an alternating current supplied to the second input unit 51. The control circuit (controller 7) is configured to, when the current measured by the current measurement device becomes zero, start the discharging operation.

### Second Embodiment

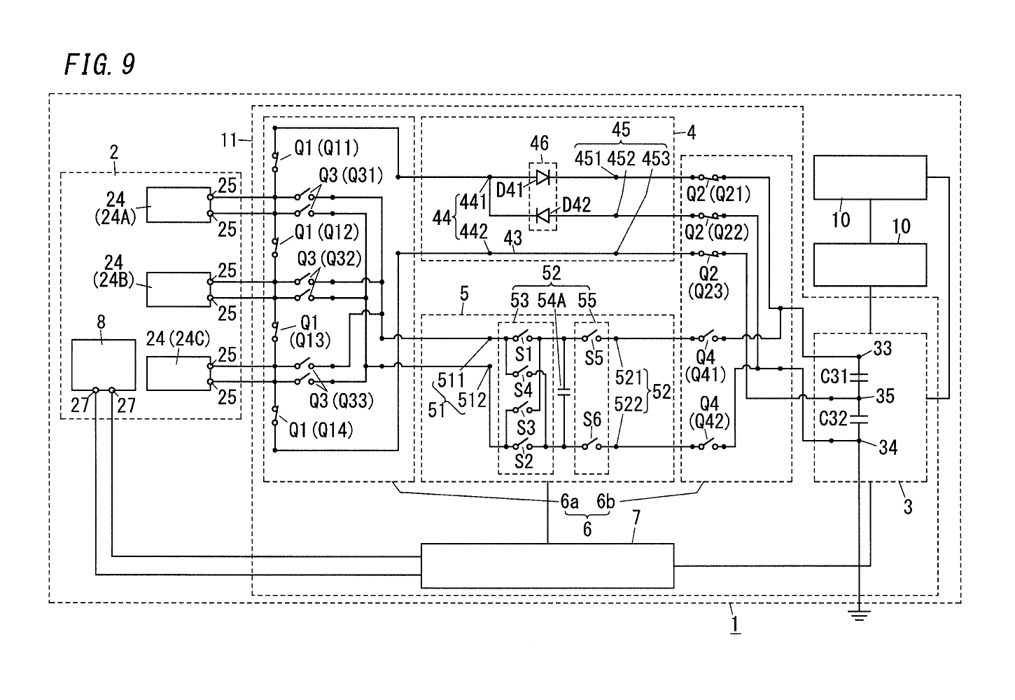

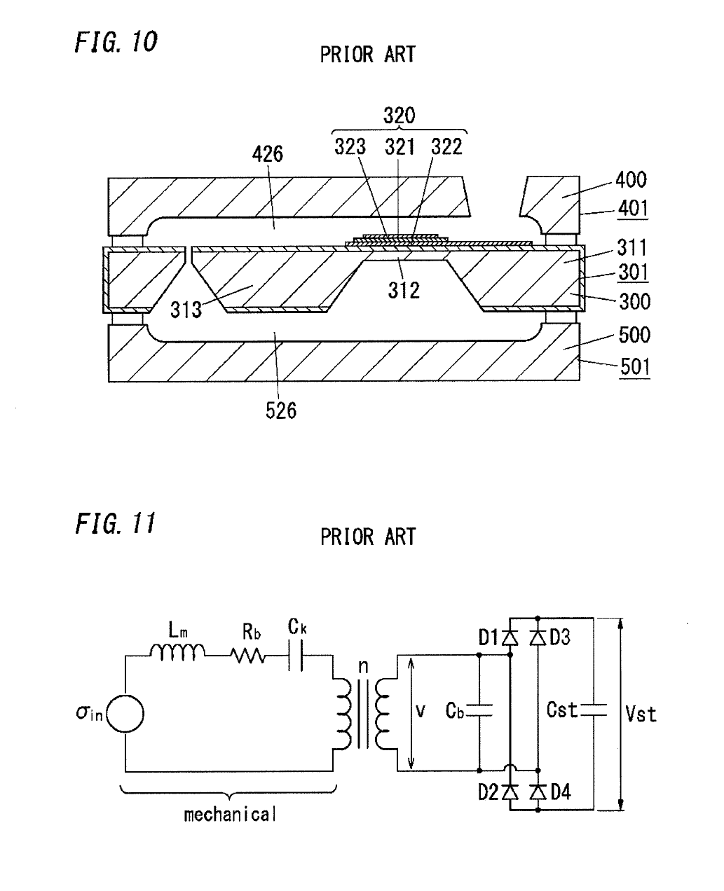

Hereinafter, the energy harvesting device 1 of the present embodiment is described with reference to FIG. 9.

The energy harvesting device 1 of the present embodiment has substantially the same basic configuration as that of the first embodiment. However, the energy harvesting device 1 of the present embodiment is different from the first embodiment in a circuit configuration of the second power extraction circuit 5. Besides, components common to the present embodiment and the first embodiment are designated by the same reference numerals and explanations thereof are deemed unnecessary.

The second power extraction circuit 5 of the energy harvesting device 1 of the first embodiment includes the energy storage device 54 constituted by the inductor. Whereas, the second power extraction circuit 5 of the energy harvesting device 1 of the present embodiment includes the energy storage device 54 (54A) constituted by a capacitor. The energy storage device 54A may be constituted by one or more capacitors.

Besides, the second power extraction circuit 5 operates in the same manner as that of the first embodiment.

Like the first embodiment, the switch circuit 6 is controlled by the controller 7 in the energy harvesting device 1 of the present embodiment. Hence, it is possible to charge the electric storage unit 3 efficiently.

Note that, the circuit configurations of the second power extraction circuits 5 described in the first and second embodiments are merely examples, and are not limited particularly. However, the second power extraction circuit 5 may have another configuration.

1. An energy harvesting device, comprising:
an electric generator for charging an electric storage; and
an power management circuit configured to operate with power from the electric storage, and to charge the electric storage with power from the electric generator,
the electric generator including two or more electric generation portions each configured to generate AC power when vibrated,
the power management circuit including
a first power extraction circuit,
a second power extraction circuit, and
a switch circuit,
the first power extraction circuit including a first input unit, a first output unit, and a rectification circuit between the first input unit and the first output unit,
the rectification circuit being configured to convert AC power received by the first input unit into DC power and provide the converted DC power to the first output unit,
the second power extraction circuit including a second input unit, a second output unit, and a switching circuit which is between the second input unit and the second output unit and is configured to operate with power supplied from the electric storage,
the switching circuit being configured to generate DC power by use of AC power received by the second input unit and provide the generated DC power to the second output unit,
the switch circuit having a first connection mode of connecting the electric generator and the electric storage to the first input unit and the first output unit, respectively, and a second connection mode of connecting the electric generator and the electric storage to the second input unit and the second output unit, respectively,
the switch circuit being configured to, in the first connection mode, connect the two or more electric generation portions to the first input unit such that an effective value of an AC voltage to be provided to the first input unit in the first connection mode is greater than an effective value of an AC voltage to be provided to the second input unit in the second connection mode, and
the switch circuit being configured to, in the second connection mode, connect the two or more electric generation portions to the second input unit such that the effective value of the AC voltage to be provided to the second input unit in the second connection mode is greater than the effective value of the AC voltage to be provided to the first input unit in the first connection mode.

2. The energy harvesting device according to claim 1, wherein
the switch circuit is configured to, in the first connection mode, make a series circuit of the two or more electric generation portions and connect the series circuit to the first input unit, and is configured to, in the second connection mode, make a parallel circuit of the two or more electric generation portions and connect the parallel circuit to the second input unit.

3. The energy harvesting device according to claim 1, wherein:
the power management circuit includes a controller configured to operate with power from the electric storage; and
the controller is configured to, when an output voltage of the electric storage is not less than a predetermined voltage, switch the switch circuit from the first connection mode to the second connection mode.

4. The energy harvesting device according to claim 3, wherein
the predetermined voltage is a minimum operating voltage of the power management circuit.

5. The energy harvesting device according to claim 4, wherein
the minimum operating voltage of the power management circuit is not less than a minimum operating voltage of the second power extraction circuit and also is not less than a minimum operating voltage of the controller.

6. The energy harvesting device according to claim 1, wherein
the switch circuit is configured to be in the first connection mode while an output voltage of the electric storage is less than a predetermined voltage.

7. The energy harvesting device according to claim 1, wherein:
the switch circuit includes
a first switch device between the electric generator and the first input unit,
a second switch device between the electric storage and the first output unit,
a third switch device between the electric generator and the second input unit, and
a fourth switch device between the electric storage and the second output unit,
each of the first switch device and the second switch device is a normally-on switch, and
each of the third switch device and the fourth switch device is a normally-off switch.

8. The energy harvesting device according to claim 1, further comprising the electric storage.

9. The energy harvesting device according to claim 8, wherein:
the electric storage includes a first capacitive element and a second capacitive element;
the rectification circuit includes a first rectifying element and a second rectifying element;
the first input unit includes a first input terminal and a second input terminal;
the first output unit includes a first output terminal, a second output terminal, and a third output terminal;
an anode of the first rectifying element and a cathode of the second rectifying element are connected to the first input terminal,
a cathode of the first rectifying element is connected to the first output terminal,
an anode of the second rectifying element is connected to the second output terminal,
the second input terminal is connected to the third output terminal, and
the switch circuit is configured to, in the first connection mode, connect the two or more electric generation portions in series between the first input terminal and the second input terminal, connect the first capacitive element and the second capacitive element in series between the first output terminal and the second output terminal, and connect the third output terminal to a connection point of the first capacitive element and the second capacitive element.

10. The energy harvesting device according to claim 1, wherein
the switching circuit includes
an energy storage device,
a first switch unit between the second input unit and the energy storage device,
a second switch unit between the second output unit and the energy storage device, and
a control circuit configured to operate with power from the electric storage, and configured to control the first switch unit and the second switch unit to convert an AC voltage received by the second input unit to a DC voltage and provide the converted DC voltage to the second output unit.

11. The energy harvesting device according to claim 10, wherein:
the control circuit is configured to, while an AC voltage to be provided to the second input unit has a positive or negative polarity, perform a storing operation in which the control circuit keeps turning off the second switch unit and controls the first switch unit so as to store energy in the energy storage device; and
the control circuit is configured to, when an AC voltage to be provided to the second input unit becomes zero, start a discharging operation in which the control circuit turns off the first switch unit and turns on the second switch unit so as to allow the energy storage device to provide a DC voltage to the second output unit.

12. The energy harvesting device according to claim 11, wherein:
the second input unit includes a third input terminal and a fourth input terminal;
the second output unit includes a fourth output terminal, and a fifth output terminal;
the first switch unit includes a first switch between a first end of the energy storage device and the third input terminal, a second switch between a second end of the energy storage device and the fourth input terminal, a third switch between the first end of the energy storage device and the fourth input terminal, and a fourth switch between the second end of the energy storage device and the third input terminal,
the second switch unit includes a fifth switch between the first end of the energy storage device and the fourth output terminal, and a sixth switch between the second end of the energy storage device and the fifth output terminal,
the switch circuit is configured to, in the second connection mode, connect the two or more electric generation portions in parallel between the third input terminal and the fourth input terminal and connect the electric storage between the fourth output terminal and the fifth output terminal,
the control circuit is configured to,
while an AC voltage to be provided to the second input unit has one of a positive polarity and a negative polarity, turn on the first switch and the second switch and turn off the third switch and the fourth switch while turning off the fifth switch and the sixth switch, so as to perform the storing operation,
while an AC voltage to be provided to the second input unit has the other of the positive polarity and the negative polarity, turn off the first switch and the second switch and turn on the third switch and the fourth switch while turning off the fifth switch and the sixth switch, so as to perform the storing operation, and
when an AC voltage to be provided to the second input unit becomes zero, turn off the first switch, the second switch, the third switch, and the fourth switch and turn on the fifth switch and the sixth switch, so as to perform the discharging operation.

13. The energy harvesting device according to claim 11, wherein:
the energy harvesting device further comprises a displacement measurement sensor;
the electric generator includes a movable portion which is movable from a basic position in response to a vibration given thereto;
the two or more electric generation portions are provided to the movable portion, and each configured to generate AC power depending on a displacement of the movable portion from the basic position;
the displacement measurement sensor is configured to measure the displacement of the movable portion from the basic position; and
the control circuit is configured to, when the displacement of the movable portion from the basic position measured by the displacement measurement sensor becomes zero, start the discharging operation.

14. The energy harvesting device according to claim 13, wherein
the displacement measurement sensor is a capacitance displacement measurement sensor.

15. The energy harvesting device according to claim 11, wherein:
the energy harvesting device further comprises a current measurement device;
the current measurement device is configured to measure an alternating current supplied to the second input unit; and
the control circuit is configured to, when the current measured by the current measurement device becomes zero, start the discharging operation.
